(19) United States
(12) Patent Application Publication
(10) Pub. No.: US 2024/0239655 A1
(43) Pub. Date: Jul. 18, 2024

(54) DEUTERIUM RECOVERY METHOD AND DEUTERIUM RECOVERY EQUIPMENT

(71) Applicant: TAIYO NIPPON SANSO CORPORATION, Tokyo (JP)

(72) Inventors: Naoki KOMURA, Tokyo (JP); Atsuhiro FUJII, Tokyo (JP)

(21) Appl. No.: 18/684,070

(22) PCT Filed: Jul. 14, 2022
(86) PCT No.: PCT/JP2022/027711

§ 371 Date: Feb. 15, 2024

(30) Foreign Application Priority Data
Aug. 25, 2021 (JP) 2021-136855

(51) Int. Cl. C01B 4/00; B01D 53/00; B01D 53/58; B01D 59/22; B01D 59/28; B01D 59/38; C01B 5/02; C01C 1/02; C25B 1/04; C25B 1/27

(52) U.S. Cl. CPC C01B 4/00; B01D 53/002; B01D 53/58; B01D 59/22; B01D 59/28; B01D 59/38; C01B 5/02; C01C 1/02; C25B 1/04; C25B 1/27; B01D 2257/108; B01D 2257/406; B01D 2257/553; B01D 2258/0216

(57) ABSTRACT

An object of the present invention is to provide a deuterium recovery method and deuterium recovery equipment that can recover and reuse deuterium or deuterium compounds used in semiconductor manufacturing processes. The present invention provides a deuterium recovery method including: generating heavy water in an exhaust gas containing deuterium gas in a semiconductor manufacturing process.

### TECHNICAL FIELD

The present invention relates to a deuterium recovery method and deuterium recovery equipment.

### BACKGROUND ART

In the semiconductor industry, hydrogen sintering is carried out in a final heat treatment of a pre-process in large scale integration (LSI) manufacturing. The purpose of hydrogen sintering is to add a hydrogen atom to bonding ends to stabilize chemically unstable dangling bonds that exist at an interface between a semiconductor substrate (silicon, Si) and an oxide film (silicon dioxide, SiO₂) in manufacturing a metal-oxide-semiconductor (MOS) structure. As hydrogen sintering, passivation is generally carried out using heated hydrogen gas at 400 to 450° C. at normal pressure for about 10 minutes. However, the terminated hydrogen atom which is added to the bonding ends is unstable and easily desorbs during use, and is a factor in the deterioration of the MOS. Therefore, termination treatment with a chemically stable deuterium having low mobility is effective for improving the reliability of the MOS.

Depending on the type of device, a protective film may be formed on the device surface, and a plasma nitride film (hereinafter also referred to as “P-SiN film”) may be used as the protective film. The purpose of the P-SiN film is to prevent the permeation of moisture and gas, and H₂ gas due to the hydrogen sintering is also difficult to permeate into the P-SiN film. Therefore, in the hydrogen sintering, it is important to introduce hydrogen atoms into the P-SiN film. The P-SiN film is usually formed to a thickness of about 1 μm by high-frequency plasma using silicon hydride (SiH₄) gas or ammonia (NH₃) gas. For this reason, research is being conducted to form the P-SiN film using deuterated silicon oxide (SiD₄) gas or deuterated ammonia (ND₃) gas. The relative value of N—H bonds and Si—H bonds that can become dangling bonds is about 100:1, and N-D bonds are most efficient in suppressing deterioration. Therefore, in order to form the N-D bonds in the P-SiN film, it is better to use deuterated ammonia (ND₃) gas rather than ammonia (NH₃) gas.

In the semiconductor industry, the use of deuterium and deuterium-containing compounds is on the rise. Although deuterium (D₂) has a lower abundance ratio than hydrogen (H₂) and is very expensive, deuterium and the deuterium-containing compounds used in hydrogen sintering and the P-SiN film formation are emitted into the air.

Therefore, recovering and reusing deuterium contributes to improving the efficiency of the semiconductor device manufacturing.

Patent Document 1 discloses a hydrogen production method in which hydrogen is produced using a steam electrolyzer that electrolyzes water vapor by operating a solid electrolyte through which oxygen ions or hydrogen ions conduct, including a steam generation step in which steam is generated using heat source of a nuclear reactor and a thermal power generator, a temperature raising step in which the temperature of the water vapor increases to a temperature of 900 K or higher at which the solid electrolyte operates, and a hydrogen generation step in which hydrogen is generated by introducing the water vapor heated to 900K or higher into the steam electrolyzer.

Patent Document 2 discloses a hydrogen production apparatus including a raw material supply system that generates mixed steam of fuel containing hydrogen and water, a reaction tube that includes a catalyst and generates hydrogen from the mixed steam supplied from the raw material supply system, and a produced gas recovery system that recovers hydrogen produced in the reaction tube, wherein the reaction tube is installed inside an exhaust gas flow path duct through which the exhaust gas from a steelmaking furnace of a steelmaking plant flows, and wherein inside the exhaust gas flow path duct, the mixed steam supplied from the raw material supply system is heated with the exhaust gas and reacted in the presence of a catalyst to generate hydrogen.

Patent Document 3 discloses a production method for a semiconductor device including a step in which a plurality of first films and a plurality of second films are alternately formed on a substrate, a step in which an opening is formed in the first films and the second films, a step in which a first insulating film, a charge storage layer, a second insulating film, and a semiconductor layer are formed in this order on sidewalls of the first films and the second films in the opening, wherein the charge storage layer includes a silicon nitride film, the second insulating film includes a silicon oxynitride film, and one or both of the silicon nitride film and the silicon oxynitride film is formed using a first gas containing silicon and a first element and a second gas containing nitrogen and deuterium.

Patent Document 4 discloses a storing method for heavy water used in the manufacturing process of semiconductor devices in a storage container, wherein a total amount of organic carbons and metals in the heavy water is maintained at 20 μg/L or less and at 1 μg/L or less by removing all organic carbons and metals in the heavy water using removal means, and a separation method for heavy water in which heavy water is condensed and recovered from heavy water-containing steam discharged from the manufacturing process of semiconductor devices.

### PRIOR ART DOCUMENTS

### Patent Documents

Patent Document 1: Japanese unexamined Patent Application, First publication No. 2006-307290
Patent Document 2: Japanese unexamined Patent Application, First publication No. 2008-013397
Patent Document 3: Japanese unexamined Patent Application, First publication No. 2021-044486
Patent Document 4: Japanese unexamined Patent Application, First publication No. 2011-146642

### SUMMARY OF INVENTION

### Problem to be Solved by the Invention

An object of the present invention is to provide a deuterium recovery method and deuterium recovery equipment that can recover and reuse deuterium or deuterium compounds used in semiconductor manufacturing processes.

### Means for Solving the Problem

[1] A deuterium recovery method including:
generating heavy water in an exhaust gas containing deuterium gas in a semiconductor manufacturing process.

[2] The deuterium recovery method according to [1], wherein when generating the heavy water, the heavy water is generated by mixing the exhaust gas and oxygen gas such that the number of moles of oxygen gas/the number of moles of deuterium gas in the exhaust gas=1 to 5.

[3] The deuterium recovery method according to [2], wherein when generating the heavy water, the heavy water is generated by reacting the deuterium gas and the oxygen gas by a catalytic reaction.

[4] The deuterium recovery method according to any one of [1] to [3], further including, after generating the heavy water, separating the heavy water from a heavy water-containing gas which is generated when generating heavy water.

[5] The deuterium recovery method according to [4], wherein when separating the heavy water, the heavy water-containing gas is cooled to liquefy and separate the heavy water, or the heavy water contained in the heavy water-containing gas is adsorbed on an adsorbent to separate.

[6] The deuterium recovery method according to [4] or [5], further including, after separating the heavy water, generating deuterium gas from the heavy water.

[7] The deuterium recovery method according to [6], wherein when generating the deuterium gas, the heavy water is electrolyzed to generate the deuterium gas.

[8] A deuterium recovery equipment for carrying out the deuterium recovery method according to any one of [1] to [7], including a heavy water generation device that generates heavy water by reacting oxygen gas with deuterium gas in an exhaust gas containing deuterium gas in a semiconductor manufacturing process.

[9] A deuterium recovery method including:
generating a deuterated ammonium salt from an exhaust gas containing deuterated ammonia gas in a semiconductor manufacturing process.

[10] A deuterium recovery method according to [9], wherein when generating the deuterated ammonium salt, the deuterated ammonium salt is produced by reacting deuterated ammonia gas in the exhaust gas with at least one selected from the group consisting of sulfuric acid, deuterated sulfuric acid, sulfurous acid, deuterated sulfurous acid, phosphoric acid, and deuterated phosphoric acid.

[11] The deuterium recovery according to [9] or [10], further including, after generating the deuterated ammonia salt, generating deuterated ammonia gas by thermally decomposing or electrolyzing the deuterated ammonium salt.

[12] A deuterium recovery equipment for carrying out the deuterium recovery method according to any one of [9] to [11], including:
a wet scrubber device that generates a deuterated ammonium salt from an exhaust gas including deuterated ammonia gas in a semiconductor manufacturing process; and
a deuterated ammonia gas generation device that generates deuterated ammonia gas by thermally decomposing or electrolyzing the deuterated ammonium salt.

[13] A deuterium recovery method including:
separating and recovering deuterated ammonia gas from an exhaust gas that has generated in a film forming process using deuterated ammonia gas (ND₃) and silane gas (SiH₄) in a semiconductor manufacturing process; and
removing the silane gas from the exhaust gas after separating and recovering the deuterated ammonia gas,
wherein when separating and recovering the deuterated ammonia gas, the deuterium recover method according to any one of [9] to is carried out.

[14] A deuterium recovery equipment for carrying out the deuterium recovery method according to [13], including:
a wet scrubber device that generates a deuterated ammonium salt from an exhaust gas that has generated in a film forming process using deuterated ammonia gas (ND₃) and silane gas (SiH₄) in a semiconductor manufacturing process; and
a silane gas remover that removes the silane gas from the exhaust gas.

### Effects of the Invention

According to the present invention, it is possible to provide a deuterium recovery method and deuterium recovery equipment that can recover and reuse deuterium or the compounds thereof used in a semiconductor manufacturing process.

### BRIEF DESCRIPTION OF DRAWINGS

FIG. 1 is a schematic diagram showing deuterium recovery equipment according to a first embodiment of the present invention.

FIG. 2 is a schematic diagram showing deuterium recovery equipment according to a second embodiment of the present invention.

FIG. 3 is a schematic diagram showing deuterium recovery equipment according to a third embodiment of the present invention.

### DETAILED DESCRIPTION OF THE PREFERRED EMBODIMENTS

Embodiments of the present invention will be described in detail below, but the present invention is not limited to the embodiments described below, and various modifications can be made without departing from the gist of the present invention.

In the present invention, hydrogen with a mass number of 2 is called deuterium, and D is used as an element symbol. Hydrogen with a mass number of 1 is sometimes called light hydrogen. Further, deuterated ammonia means a compound represented by the chemical formula ND₃, and deuterated ammonium salt means a salt in which three or four of the four hydrogen atoms of the ammonium cation of an ammonium salt are substituted with deuterium atoms. Deuterated sulfuric acid means an inorganic acid represented by the chemical formula H₂SO₄ in which two hydrogen atoms of sulfuric acid are replaced with deuterium atoms. Deuterated phosphoric acid means an inorganic acid represented by the chemical formula H₃PO₄ in which three hydrogen atoms of phosphoric acid (orthophosphoric acid) are replaced with deuterium atoms.

### First Embodiment

A first embodiment of the present invention is a deuterium recovery method and deuterium recovery equipment for recovering deuterium or a compound thereof from an exhaust gas containing deuterium gas in a semiconductor manufacturing process.

### <Deuterium Recovery Equipment>

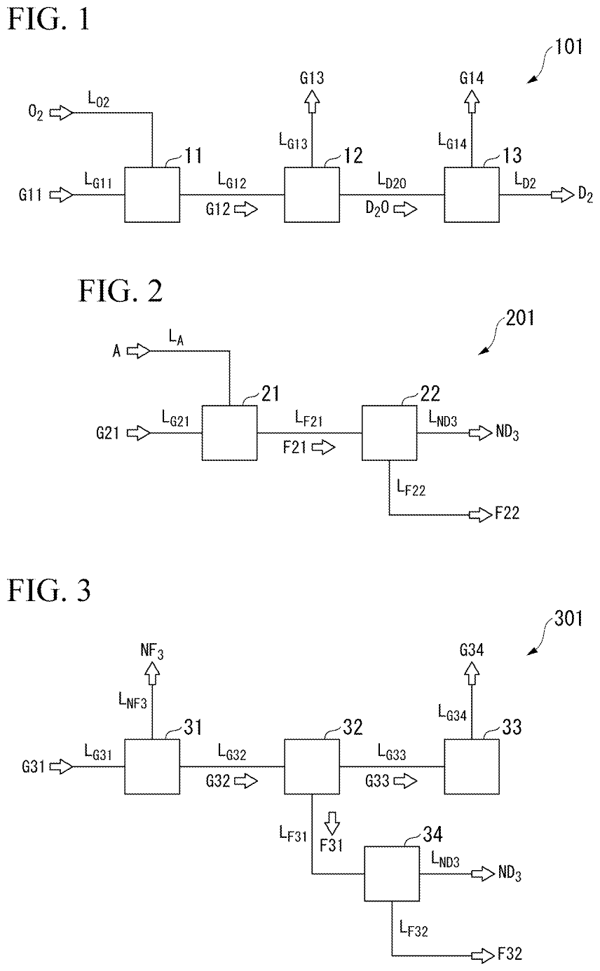

The deuterium recovery equipment 101 shown in FIG. 1 is the deuterium recovery equipment according to the first embodiment of the present invention. The deuterium recovery equipment 101 is equipment for recovering deuterium or compounds thereof from an exhaust gas G11 containing deuterium gas discharged in a semiconductor manufacturing process.

The deuterium recovery equipment 101 includes a heavy water generation device 11, a heavy water separation device 12; a deuterium gas generation device 13; an exhaust gas introduction line Lon which supplies an exhaust gas G11 into the heavy water generation device 11; a supply line L_{O2} which supplies oxygen gas O₂ into the heavy water generation device 11; a transfer line L_{G12} which leads out a heavy water-containing gas G₁₂ generated in the heavy water generation device 11 and introduces it into the heavy water separation device 12; a transfer line L_{D2O} which leads out heavy water D₂O separated in the heavy water separation device 12 and introduces it into the deuterium gas generation device 13; a lead-out line L_{D2} which leads out deuterium gas from the deuterium gas generation device 13; an exhaust gas discharge line L_{G13} that discharges an exhaust gas G13 from the heavy water separation device 12; and an exhaust gas discharge line L_{G14} which discharges an exhaust gas G14 from the deuterium gas generation device 13.

### (Heavy Water Generation Device)

The heavy water generation device 11 is a device for generating heavy water-containing gas G12 by reacting deuterium gas D₂ in the exhaust gas G11 with oxygen gas O₂ supplied from the outside. The heavy water generation device 11 includes a synthesis section (not shown) for synthesizing heavy water D₂O by oxidizing deuterated gas D₂ with the oxygen gas O₂. The synthesis of heavy water D₂O in the synthesis section is carried out by contacting a mixed gas of the exhaust gas G11 containing deuterium gas D₂ and the oxygen gas O₂ with a catalyst, or by combusting a mixed gas of the exhaust gas G11 containing deuterium gas D₂ and the oxygen gas O₂.

As the catalyst, a metal platinum, metal palladium, an alloy of platinum, an alloy of palladium, a compound of platinum, or a compound of palladium is used. When deuterium gas D₂ is oxidized using the catalyst, the catalyst is preferably porous in order to increase the contact area between the mixed gas and the catalyst.

### (Heavy Water Separation Device)

The heavy water separation device 12 is a device for separating heavy water D₂O from the heavy water-containing gas G12 generated by the heavy water generation device 11. The heavy water separation device 12 includes a separation section (not shown) for separating the heavy water D₂O from the heavy water-containing gas G12. The heavy water D₂O is separated in the separation section by cooling the heavy water-containing gas G12 with a cooler (not shown) and condensing and liquefying the heavy water D₂O in a gaseous state, or by adsorbing the heavy water D₂O in a gaseous state in the heavy water-containing gas G12 with a desiccant packed in an adsorption column (not shown). The heavy water D₂O separated in the separation section is transferred into the deuterium gas generation device 13 through the transfer line L_{D2O}. Exhaust gas G13 generated in the separation section is discharged to the outside of the system through the exhaust gas discharge line L_{G13}.

In addition, when recovering deuterium as heavy water D₂O, the heavy water D₂O separated in the separation section may be recovered without being transferred into the deuterium gas generation device 13.

### (Deuterium Gas Generation Device)

The deuterium gas generation device 13 is a device for generating deuterium gas D₂ from the heavy water D₂O (liquid) separated by the heavy water separation device 12. The deuterium gas generation device 13 includes a reaction section (not shown) for generating deuterium gas D₂ from the heavy water D₂O. The deuterium gas D₂ is generated in the reaction section by electrolyzing the heavy water D₂O. The deuterium gas D₂ generated in the reaction section is recovered through the lead-out line L_{D2}. Exhaust gas G14 generated in the reaction section is discharged to the outside of the system through the exhaust gas discharge line L_{G14}.

### <Deuterium Recovery Method>

Hereinafter, a deuterium recovery method using the deuterium recovery equipment 101 of the present embodiment described above will be explained.

### (Heavy Water Generation Step)

The deuterium recovery method of the present embodiment includes a heavy water generation step in which heavy water is generated in the exhaust gas containing deuterium gas in a semiconductor manufacturing process.

The heavy water generation step is carried out in the heavy water generation device 11 of the deuterium recovery equipment 101 shown in FIG. 1.

In the heavy water generation step in the heavy water generation device 11, the deuterium gas D₂ in the exhaust gas G11 is reacted with oxygen gas O₂ supplied from the outside of the heavy water generation device 11 in a synthesis section (not shown) of the heavy water generation device 11. Specifically, the reaction between the deuterium gas D₂ and the oxygen gas O₂ is preferably carried out by bringing a mixed gas of the exhaust gas G11 and the oxygen gas O₂ into contact with a catalyst, or by combusting the mixed gas.

The catalyst is preferably a metal, an alloy, or a compound of platinum or palladium. A specific example of the catalyst is a palladium carbon catalyst (Pd/C).

The temperature at which the mixed gas and the catalyst are brought into contact is not particularly limited, but is preferably 400 to 580° C., and more preferably 500 to 580° C.

The quantitative ratio of the deuterium gas D₂ and the oxygen gas O₂ when oxidizing the deuterium gas D₂ in the exhaust gas G11 is preferably such that the number of moles of oxygen gas O₂/the number of moles of deuterium gas D₂=1 to 5, and more preferably 1 to 3 from the viewpoint of the recovery efficiency of deuterium. Since the organic substances in the exhaust gas G11 become catalyst poisons, the organic substances can be removed by adding an excessive amount of oxygen gas O₂.

In the heavy water generation step, the deuterium gas D₂ in the exhaust gas G11 is converted to heavy water D₂O, which is led out from the heavy water generation device 11 as a heavy water-containing gas G12. When recovering deuterium as heavy water D₂O, the heavy water-containing gas G12 may be recovered as the target substance.

The reaction between deuterium gas and oxygen gas is as follows.

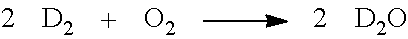

### (Heavy Water Separation Step)

The deuterium recovery method of the present embodiment may further include, after the heavy water generation step, a heavy water separation step of separating the heavy water from the heavy water-containing gas generated in the heavy water generation step.

The heavy water separation step is carried out in the heavy water separation device 12 of the deuterium recovery equipment 101 shown in FIG. 1.

The heavy water separation step in the heavy water separation device 12 is preferably carried out by cooling the heavy water-containing gas G12 with a cooler (not shown) and condensing and liquefying the heavy water D₂O in a gaseous state, or by adsorbing the heavy water D₂O in a gaseous state in the heavy water-containing gas G12 to a desiccant packed in an adsorption tower (not shown) in the separation section (not shown) of the heavy water separation device 12.

The temperature at which the heavy water-containing gas G12 is cooled is not particularly limited, but is preferably 0 to 25° C., and more preferably 0 to 10° C. Since the boiling point of heavy water is 101.4° C. (1013 hPa), it is not necessary to cool the heavy water-containing gas G12 to around the freezing point of heavy water. By cooling it to about room temperature (25° C.), most of heavy water in the heavy water-containing gas G12 can be liquefied. However, the recovery rate will be improved if it is further cooled. Examples of the cooling method include heat exchange with general industrial water.

Examples of the desiccant (adsorbent) include silica gel and molecular sieve.

Liquefaction by cooling and adsorption of heavy water by an adsorbent may be combined. In this case, it is preferable to cool the heavy water-containing gas G12 to liquefy and recover most of the heavy water contained therein, and then adsorb and recover the remaining heavy water using the adsorbent.

### (Deuterium Gas Generation Step)

The deuterium recovery method of the present embodiment may further include, after the heavy water separation step, a deuterium gas generation step of generating deuterium gas from the heavy water separated in the heavy water separation step.

The deuterium gas generation step is carried out in the deuterium gas generation device 13 of the deuterium recovery equipment 101 shown in FIG. 1.

The deuterium gas generation step in the deuterium gas generation device 13 is carried out by electrolyzing the heavy water D₂O to generate deuterium gas D₂ in the reaction section (not shown) of the deuterium gas generation device 13.

The electrolysis of the heavy water D₂O can be carried out in the same manner as the conventionally known electrolysis of light water H₂O, and deuterium gas D₂ is generated at a cathode and oxygen gas O₂ is generated at tan anode.

In the deuterium recovery method of the present embodiment, in addition to recycling the deuterium gas D₂ generated at the cathode to semiconductor manufacturing equipment, it is also possible to recover and use the heavy water as it is.

### Effect

In order to directly recover deuterium from the exhaust gas G11 containing deuterium, it is necessary to lower the temperature to an extremely low temperature of −253° C. or lower in order to liquefy the deuterium gas, which is not realistic. For this reason, in the deuterium recovery method and the deuterium recovery equipment of the present embodiment, heavy water D₂O is synthesized from deuterium gas D₂ in the exhaust gas G11, separated, and further electrolyzed to recover deuterium gas D₂. Thereby, recovery of deuterium gas D₂ from the exhaust gas G11 is achieved with high efficiency and low cost.

### Second Embodiment

A second embodiment of the present invention is a deuterium recovery method and deuterium recovery equipment for recovering deuterium or a compound thereof from an exhaust gas containing deuterated ammonia gas discharged in a semiconductor manufacturing process.

### <Deuterium Recovery Equipment>

The deuterium recovery equipment 201 shown in FIG. 2 is a deuterium recovery equipment according to the second embodiment of the present invention. The deuterium recovery equipment 201 is equipment for recovering deuterated ammonia gas from an exhaust gas G21 containing deuterated ammonia gas discharged in a semiconductor manufacturing process.

The deuterium recovery equipment 201 includes a wet scrubber device 21; a deuterated ammonia gas generation device 22; an exhaust gas introduction line L_{G21} for supplying the exhaust gas G21 into the wet scrubber device 21; a transfer line L_{F21} for leading out fluid F21 from the wet scrubber device 21; a lead-out line L_{ND3} for leading out deuterated ammonia gas ND₃ from the deuterated ammonia gas generation device 22; and a discharge line L_{F22} for discharging the remaining fluid F22 which is produced by removing the deuterated ammonia gas ND₃ from the fluid F21

### (Wet Scrubber Device)

The wet scrubber device 21 is a device for producing a deuterated ammonium salt by reacting the deuterated ammonia gas ND₃ in the exhaust gas G21 with at least one A (hereinafter also referred to as “inorganic acid A”) selected from the group consisting of sulfuric acid H₂SO₄, deuterated sulfuric acid D₂SO₄, sulfurous acid H₂SO₃, deuterated sulfurous acid D₂SO₃, phosphoric acid H₃PO₄, and deuterated phosphoric acid D₃PO₄. The wet scrubber device 21 includes a reaction section (not shown) that reacts the deuterated ammonia gas ND₃ in the exhaust gas G21 with the inorganic acid A to generate the deuterated ammonium salt. The production of deuterated ammonium salt in the reaction section is formally carried out by an acid-base reaction between the deuterated ammonia gas ND₃ and the inorganic acid A. For example, the following reactions occur between the deuterated ammonia gas ND₃ and the inorganic acid A.

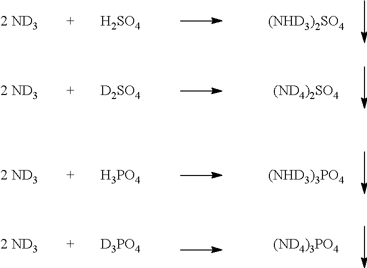

The generated deuterated ammonium salt precipitates in the reaction section as a solid. The transfer line L_{F21} is a line for transferring the deuterated ammonium salt precipitated in the reaction section into the deuterated ammonia gas generation device 22 as a fluid F21 together with a liquid in the reaction section.

### (Deuterated Ammonia Gas Generation Device)

The deuterated ammonia gas generation device 22 is a device for electrolyzing or thermally decomposing the deuterated ammonium salt contained in the fluid F21 generated by the wet scrubber device 21 to generate the deuterated ammonia gas ND₃. The deuterated ammonia gas generation device 22 includes a reaction section (not shown) that generates the deuterated ammonia gas ND₃ by electrolyzing or thermally decomposing the deuterated ammonium salt.

The electrolysis of the deuterated ammonium salt in the reaction section can be carried out by a conventionally known ammonium salt electrolysis method. Furthermore, the thermal decomposition of the deuterated ammonium salt in the reaction section can be carried out by a conventionally known method for thermally decomposing ammonium salts.

The generated deuterated ammonia gas ND₃ is recovered through the lead-out line L_{ND3} and reused in the semiconductor manufacturing process.

The remaining fluid F22 which has generated by generating and removing the deuterated ammonia gas ND₃ from the fluid F21 is discharged to the outside of the system through the discharge line L_{F22}.

### <Deuterium Recovery Method>

The deuterium recovery method of the present embodiment includes a deuterated ammonium salt generation step of generating the deuterated ammonium salt from the exhaust gas containing deuterated ammonia gas in a semiconductor manufacturing process.

### (Deuterated Ammonium Salt Generation Step)

The deuterated ammonium salt generation step is carried out in the wet scrubber device 21 of the deuterium recovery equipment 201 shown in FIG. 2.

In the deuterated ammonium salt generation step in the wet scrubber device 21, it is preferable to react the deuterated ammonia gas ND₃ in the exhaust gas G21 with at least one A (hereinafter also referred to as “inorganic acid A”) selected from the group consisting of sulfuric acid, deuterated sulfuric acid, sulfurous acid, deuterated sulfurous acid, phosphoric acid, and deuterated phosphoric acids in the reaction section (not shown) of the wet scrubber device 21.

In the deuterated ammonium salt generation step, in order to reduce the influence of light hydrogen H, it is preferable to use deuterated sulfuric acid D₂SO₄ or deuterated phosphoric acid D₃PO₄ as the inorganic acid A.

As a solvent for dissolving the inorganic acid A, light water H₂O or heavy water D₂O can be used. In order to reduce the influence of light hydrogen H, it is preferable to use heavy water D₂O as a solvent for dissolving the inorganic acid A.

Furthermore, instead of adding deuterated sulfuric acid into the solvent, the deuterated ammonium salt may be generated while bubbling sulfur trioxide SO₃ into heavy water D₂O to generate deuterated sulfuric acid D₂SO₄.

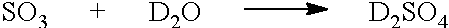

Furthermore, instead of adding deuterated sulfuric acid into the solvent, the deuterated ammonium salt may be generated while bubbling sulfur dioxide SO₂ into heavy water D₂O to generate deuterated sulfurous acid D₂SO₃.

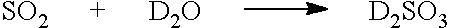

However, in the reaction between deuterated sulfurous acid and deuterated ammonia, (ND₄)₂SO₃·D₂O precipitates and consumes expensive heavy water D₂O, so it is necessary to control the supply of SO₂ and D₂O by monitoring the concentration thereof.

Further, instead of adding deuterated phosphoric acid into the solvent, deuterated ammonium salt may be generated while dissolving phosphorus pentoxide P₂O₅ in heavy water D₂O to generate deuterated phosphoric acid.

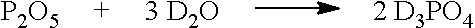

### (Deuterated Ammonia Gas Generation Step)

The deuterium recovery method of the present embodiment may further include, after the deuterated ammonium salt generation step, a deuterated ammonia gas generation step of thermally decomposing or electrolyzing the deuterated ammonium salt to generate deuterated ammonia gas.

The electrolysis of the deuterated ammonium salt in the deuterated ammonia gas generation step can be carried out by a conventionally known ammonium salt electrolysis method. Furthermore, the thermal decomposition of the deuterated ammonium salt in the reaction section can be carried out by a conventionally known method for thermally decomposing ammonium salts.

The generated deuterated ammonia gas ND₃ is recovered through the lead-out line L_{ND3} and reused in the semiconductor manufacturing process.

### Effect

In order to directly recover the deuterated ammonia from the exhaust gas G21 containing deuterated ammonia, it is necessary to pressurize (about 9000 hPa) or cool (about −33° C.) to liquefy the deuterated ammonia, which is not realistic. For this reason, in the deuterium recovery method and deuterium recovery equipment of the present embodiment, deuterated ammonium salt is generated from deuterated ammonia gas ND₃ in the exhaust gas G21, separated, and further thermally decomposed or electrolyzed. Thereby, recovery of deuterated ammonia gas ND₃ from the exhaust gas G21 is achieved with high efficiency and low cost.

### Third Embodiment

A third embodiment of the present invention is a deuterium recovery method and deuterium recovery equipment for recovering deuterated ammonia gas from an exhaust gas containing deuterated ammonia gas and silane gas discharged in a semiconductor manufacturing process.

### <Deuterium Recovery Equipment>

The deuterium recovery equipment 301 shown in FIG. 3 is the deuterium recovery equipment according to the third embodiment of the present invention. The deuterium recovery equipment 301 is the equipment for recovering deuterated ammonia gas from an exhaust gas containing deuterated ammonia gas and silane gas generated in a film forming process using deuterated ammonia gas (ND₃) and silane gas (SiH₄) in a semiconductor manufacturing process.

The deuterium recovery equipment 301 includes a nitrogen trifluoride remover 31; a wet scrubber device 32; a silane gas remover 33; a deuterated ammonia gas generation device 34, an exhaust gas introduction line L_{G31} for supplying an exhaust gas G31 into the nitrogen trifluoride remover 31; a NF₃ discharge line L_{NF3} for discharging NF₃ from the nitrogen trifluoride remover 31; a transfer line L_{G32} for transferring gas G32 which is produced by removing nitrogen trifluoride gas NF₃ from the exhaust gas G31 into the wet scrubber device 32; a transfer line L_{G33} for transferring gas G33 which is produced by removing the deuterated ammonia gas ND₃ from the gas G32 into silane gas remover 33; a transfer line L_{F31} for transferring a fluid F31 containing the deuterated ammonium salt generated in the wet scrubber device 32 into a deuterated ammonia gas generation device 34; and a lead-out line L_{ND3} for leading out the deuterated ammonia gas ND₃ from the deuterated ammonia gas generation device 34.

### (Nitrogen Trifluoride Remover)

The nitrogen trifluoride remover 31 is a device for removing nitrogen trifluoride gas (NF₃) from the exhaust gas G31 generated in a film forming process using deuterated ammonia gas (ND₃) and silane gas (SiH₄) in the semiconductor manufacturing process. Since nitrogen trifluoride gas NF₃ is used as an etching gas, it is usually included in the exhaust gas from the film forming process. Since nitrogen trifluoride gas NF₃ is toxic to the human body, it is removed from the exhaust gas G31.

As the nitrogen trifluoride remover 31, a conventionally used nitrogen trifluoride remover can be used.

The gas G32 which is produced by removing nitrogen trifluoride gas NF3 from the exhaust gas G31 is transferred into the wet scrubber device 32 through the transfer line L_{G32}.

### (Wet Scrubber Device, and Deuterated Ammonia Gas Generation Device)

The wet scrubber device 32 is a device for reacting the deuterated ammonia gas in the exhaust gas with at least one B (hereinafter also referred to as “inorganic acid B”) selected from the group consisting of sulfuric acid H₂SO₄, deuterated sulfuric acid D₂SO₄, sulfurous acid H₂SO₃, deuterated sulfurous acid D₂SO₃, phosphoric acid H₃PO₄, and deuterated phosphoric acid D₃PO₄, and generating a deuterated ammonium salt. The wet scrubber device 32 includes a reaction section (not shown) that reacts the deuterated ammonia gas ND₃ in the gas G32 with inorganic acid B to generate the deuterated ammonium salt. The generation of the deuterated ammonium salt in the reaction section is formally carried out by an acid-base reaction between the deuterated ammonia gas ND₃ and the inorganic acid B. For example, the following reactions occur between the deuterated ammonia gas ND₃ and the inorganic acid B.

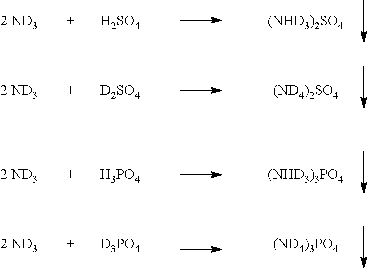

The generated deuterated ammonium salt precipitates in the reaction section as a solid. The transfer line L_{F31} is a line for transferring the deuterated ammonium salt precipitated in the reaction section into the deuterated ammonia gas generation device 34 as a fluid F31 together with a liquid in the reaction section.

The deuterated ammonia gas generation device 34 is a device for electrolyzing or thermally decomposing the deuterated ammonium salt in the fluid F31 generated by the wet scrubber device 32 to generate deuterated ammonia gas ND₃. The deuterated ammonia gas generation device 34 includes a reaction section (not shown) that generates the deuterated ammonia gas ND₃ by electrolyzing or thermally decomposing the deuterated ammonium salt.

The electrolysis of the deuterated ammonium salt in the reaction section can be carried out by a conventionally known ammonium salt electrolysis method. Furthermore, the thermal decomposition of the deuterated ammonium salt in the reaction section can be carried out by a conventionally known method for thermally decomposing ammonium salts.

The generated deuterated ammonia gas ND₃ is recovered through the lead-out line L_{ND3} and reused in the semiconductor manufacturing process.

The discharge line L_{F32} is a line for discharging the remaining fluid F32, which has generated by generating and removing the deuterated ammonia gas ND₃ from the fluid F31, to the outside of the system.

### (Silane Gas Remover)

The silane gas remover 33 is a device for removing silane gas SiH₄ from the remaining gas G33 which has generated by generating and removing the deuterated ammonia gas from the gas G32. In the silane gas remover 33, the silane gas SiH₄ is removed from the gas G33 as a solid content (powder) such as silicon dioxide SiO₂ by combustion. The discharge line L_{G34} is a line for discharging the gas G34, which is produced by removing the silane gas SiH₄ from the gas G33 as a solid content (powder), to the outside of the system.

### <Deuterium Recovery Method>

The deuterium recovery method of the present embodiment includes: a deuterated ammonia gas separation step in which deuterated ammonia gas is separated from the exhaust gas containing deuterated ammonia gas ND₃ and silane gas SiH₄ generated in a film forming step using deuterated ammonia gas ND₃ and silane gas SiH₄ in the semiconductor manufacturing process; and a silane gas removing step in which the silane gas SiH₄ is removed from an exhaust gas which is generated by removing the deuterated ammonia gas ND₃ from the exhaust gas.

The deuterium recovery method of the present embodiment is carried out in deuterium recovery equipment 301 shown in FIG. 3.

### (Nitrogen Trifluoride Gas Removing Step)

Before the deuterated ammonia gas separation step, it is preferable to remove nitrogen trifluoride gas NF3 used as an etching gas from the exhaust gas G31. The gas G32 which is produced by removing the nitrogen trifluoride gas NF3 from the exhaust gas G31 is treated in the deuterated ammonia gas separation step.

### (Deuterated Ammonia Gas Separation Step)

It is preferable that the deuterated ammonium salt generation step in the wet scrubber device 32 be carried out by reacting the deuterated ammonia gas ND₃ in the gas G32 with at least one B (hereinafter also referred to as “inorganic acid B”) selected from the group consisting of sulfuric acid, deuterated sulfuric acid, sulfurous acid, deuterated sulfurous acid, phosphoric acid, and deuterated phosphoric acid, and generating the deuterated ammonium salt.

In the deuterated ammonium salt generation step, in order to reduce the influence of light hydrogen H, it is preferable to use deuterated sulfuric acid D₂SO₄ or deuterated phosphoric acid D₃PO₄ as the inorganic acid B.

As a solvent for dissolving inorganic acid B, light water H₂O or heavy water D₂O can be used. In order to reduce the influence of light hydrogen H, it is preferable to use heavy water D₂O as a solvent for dissolving the inorganic acid B.

Furthermore, instead of adding deuterated sulfuric acid into the solvent, the deuterated ammonium salt may be generated while bubbling sulfur trioxide SO₃ into heavy water D₂O to generate deuterated sulfuric acid D₂SO₄.

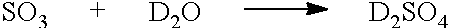

Furthermore, instead of adding deuterated sulfuric acid into the solvent, deuterated ammonium salt may be generated while generating deuterated sulfurous acid D₂SO₃ by bubbling sulfur dioxide SO₂ into heavy water D₂O.

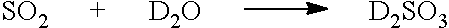

Further, instead of adding deuterated phosphoric acid into the solvent, the deuterated ammonium salt may be generated while dissolving phosphorus pentoxide P₂O₅ in heavy water D₂O to generate deuterated phosphoric acid.

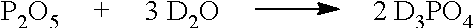

After the deuterated ammonium salt generation step, a deuterated ammonia gas generation step, in which the deuterated ammonium salt is thermally decomposed or electrolyzed to generate the deuterated ammonia gas, is carried out.

The deuterated ammonium salt precipitated in the reaction section is transferred into the deuterated ammonia gas generation device 34 through the transfer line L_{F31} as the fluid F31 together with a liquid in the reaction section.

The electrolysis of the deuterated ammonium salt in the deuterated ammonia gas generation step can be carried out by a conventionally known ammonium salt electrolysis method. Furthermore, the thermal decomposition of the deuterated ammonium salt in the reaction section can be carried out by a conventionally known method for thermally decomposing ammonium salts.

The generated deuterated ammonia gas ND₃ is recovered through the lead-out line L_{ND3} and reused in the semiconductor manufacturing process.

### (Silane Gas Removing Step)

The gas G33 generated in the wet scrubber device 32 in the deuterated ammonia gas separation step is transferred into the silane gas remover 33 through the transfer line L_{G33}.

The removal of the silane gas SiH₄ from the gas G33 is carried out by a conventionally known silane gas removal method.

In the silane gas remover 33, the silane gas SiH₄ is converted into a solid content (powder) such as silicon oxide SiO₂ by combustion, and is removed from the exhaust gas. A gas G34 after removing the silane gas SiH₄ by combustion is discharged to the outside of the recovery equipment system through a discharge line L_{G34}.

### Effect

In order to directly recover the deuterated ammonia from the exhaust gas containing deuterated ammonia, it is necessary to pressurize (approximately 9000 hPa) or cooling (approximately −33° C.) to liquefy the deuterated ammonia, which is not realistic. For this reason, in the deuterium recovery method and the deuterium recovery equipment of the present embodiment, the deuterated ammonium salt is generated from the deuterated ammonia gas ND₃ in the exhaust gas, separated, and further thermally decomposed or electrolyzed to recover the deuterated ammonia gas ND₃. Thereby, recovery of deuterated ammonia gas ND₃ from the exhaust gas is achieved with highly efficiency and low cost.

### EXPLANATION OF SYMBOLS

11 heavy water generation device
12 heavy water separation device
13 deuterium gas generation device
21 wet scrubber device
22 deuterated ammonia gas generation device
31 nitrogen trifluoride remover
32 wet scrubber device
33 silane gas remover
34 deuterated ammonia gas generation device
101, 201, 301 deuterium recovery equipment
F21, F22, F31, F32 fluid
G11, G13, G14, G21, G31 exhaust gas
G12 heavy water containing gas
G32, G33, G34 gas
L_{D2} lead-out line
L_{D2O}, L_{F21}, L_{F31}, L_{G12} transfer line
L_{F22}, L_{F32}, L_{G34}, L_{NF3} discharge line
L_{G11}, L_{G21}, L_{G31} exhaust gas introduction line
L_{G13}, L_{G14} exhaust gas discharge line
L_{G32}, L_{G33} transfer line
L_{ND3} lead-out line
L_{O2} supply line

1. A deuterium recovery method comprising:
generating heavy water in an exhaust gas containing deuterium gas in a semiconductor manufacturing process.

2. The deuterium recovery method according to claim 1, wherein when generating the heavy water, the heavy water is generated by mixing the exhaust gas and oxygen gas such that the number of moles of oxygen gas/the number of moles of deuterium gas in the exhaust gas=1 to 5.

3. The deuterium recovery method according to claim 2, wherein when generating the heavy water, the heavy water is generated by reacting the deuterium gas and the oxygen gas by a catalytic reaction.

4. The deuterium recovery method according to claim 1, further comprising, after generating the heavy water, separating the heavy water from a heavy water-containing gas which is generated when generating heavy water.

5. The deuterium recovery method according to claim 4, wherein when separating the heavy water, the heavy water-containing gas is cooled to liquefy and separate the heavy water, or the heavy water contained in the heavy water-containing gas is adsorbed on an adsorbent to separate.

6. The deuterium recovery method according to claim 4, further comprising, after separating the heavy water, generating deuterium gas from the heavy water.

7. The deuterium recovery method according to claim 6, wherein when generating the deuterium gas, the heavy water is electrolyzed to generate the deuterium gas.

8. A deuterium recovery equipment for carrying out the deuterium recovery method according to claim 1, comprising a heavy water generation device that generates heavy water by reacting oxygen gas with deuterium gas in an exhaust gas containing deuterium gas in a semiconductor manufacturing process.

9. A deuterium recovery method comprising:
generating a deuterated ammonium salt from an exhaust gas containing deuterated ammonia gas in a semiconductor manufacturing process.

10. A deuterium recovery method according to claim 9, wherein when generating the deuterated ammonium salt, the deuterated ammonium salt is produced by reacting deuterated ammonia gas in the exhaust gas with at least one selected from the group consisting of sulfuric acid, deuterated sulfuric acid, sulfurous acid, deuterated sulfurous acid, phosphoric acid, and deuterated phosphoric acid.

11. The deuterium recovery according to claim 9, further comprising, after generating the deuterated ammonia salt, generating deuterated ammonia gas by thermally decomposing or electrolyzing the deuterated ammonium salt.

12. A deuterium recovery equipment for carrying out the deuterium recovery method according to claim 9, comprising:
a wet scrubber device that generates a deuterated ammonium salt from an exhaust gas comprising deuterated ammonia gas in a semiconductor manufacturing process; and
a deuterated ammonia gas generation device that generates deuterated ammonia gas by thermally decomposing or electrolyzing the deuterated ammonium salt.

13. A deuterium recovery method comprising:
separating and recovering deuterated ammonia gas from an exhaust gas that has generated in a film forming process using deuterated ammonia gas (ND₃) and silane gas (SiH₄) in a semiconductor manufacturing process; and
removing the silane gas from the exhaust gas after separating and recovering the deuterated ammonia gas,
wherein when separating and recovering the deuterated ammonia gas, the deuterium recover method according to claim 9 is carried out.

14. A deuterium recovery equipment for carrying out the deuterium recovery method according to claim 13, comprising:
a wet scrubber device that generates a deuterated ammonium salt from an exhaust gas that has generated in a film forming process using deuterated ammonia gas (ND₃) and silane gas (SiH₄) in a semiconductor manufacturing process; and
a silane gas remover that removes the silane gas from the exhaust gas.
